(19) United States
(12) Patent Application Publication
(10) Pub. No.: US 2005/0229175 A1
(43) Pub. Date: Oct. 13, 2005

(54) Hardware agnostic manipulation and management of image resources

(75) Inventors: Dave D. McCrory, Austin, TX (US); Ghassan Yammine, Georgetown, TX (US); Neal Prager, Austin, TX (US); Robert A. Hirschfeld, Austin, TX (US)

Correspondence Address: LAW OFFICES OF GARY R. STANFORD, 330 W OVERLOOK MOUNTAIN RD, BUDA, TX, 78610, US

(73) Assignee: Surgient, Inc., Austin, TX (US)

(21) Appl. No.: 10/823,342

(22) Filed: Apr. 13, 2004

(51) Int. Cl. G06F 9/445

(52) U.S. Cl. 717/177

(57) ABSTRACT

A conversion system for converting a source disk image supporting a first hardware configuration into a target disk image supporting a second and different hardware configuration. The conversion system includes a first server that mounts the source disk image as a target disk drive, a repository that stores information and files useful for supporting the second hardware configuration, a rules library that facilitates conversion of hardware specific attributes in accordance with an external introspection process (EIP), and a conversion engine executed on the first server and interfaced with the repository and the rules library. The conversion engine performs the EIP by examining the source disk image on the target disk drive to determine modifications to convert to the target disk image.

### BACKGROUND OF THE INVENTION

1. Field of the Invention

The present invention relates to server systems and management, and more particularly to hardware agnostic manipulation and management of image resources for converting a disk drive image bootable by one server to a bootable disk drive image for another system with a different hardware configuration.

2. Description of the Related Art

The operating system (OS) of a computer must be configured to operate for a given hardware computing platform capable of running the particular OS. Many operating systems typically incorporate one or more self-discovery mechanisms that identify the operating environment and adjust configurations to enable the platform to run the OS. The bootstrap process, for example, loads the appropriate operating environment for the OS, and performs an initial load of the software and hardware platforms into active memory of the hardware. Since the process may not be completed, it is hoped that the bootstrap process has sufficient information to adjust configurations and re-attempt boot if necessary. Plug and Play is an automated discovery process that identifies and publishes hardware specific information in order for the OS to match the hardware with hardware specific software.

It is often desired to convert a bootable platform from one system to another. A particularly useful function is to essentially copy or clone a bootable hard drive for multiple systems with the same or very similar hardware configurations to facilitate the manufacturing process. A Microsoft® tool called SysPrep, for example, is designed for corporate system administrators, OEMs, and others to clone a computer with a selected Windows® operating system (e.g., XP) to another computer. SysPrep replaces configuration information of the source machine with configuration information specific to the target machine to generate a usable system. The boot process of the target machine still relies somewhat on the self-discovery mechanisms to complete the process if the hardware configuration is not identical.

It is also advantageous to convert a physical system to a virtual machine (VM) or logical server (LS). The term “server” as used herein connotes any computing platform capable of running an OS, whether physical or virtual, any generally includes any computer system or personal computer (PC). Virtualization software converts a single physical server into a pool of logical computing resources including one or more logical servers. Each logical server employs an OS encompassed by virtualization software, so that the OS operates as though the underlying platform is physical rather than virtual. Each logical server is intended to simulate a physical server so that the end-user may be unaware that the underlying computer platform is virtual rather than physical. At least one physical to virtual or P2V tool has been developed to convert a physical platform to a corresponding virtual or logical platform. The P2V tool is an imaging process in which the target image file functions as a hard disk file for a VM. A disk drive “image” is a portable description (e.g., a set of one or more files) of hardware persistent storage and includes hardware specific configuration information and drivers. The information contained on the bootable disk drive of the physical machine is converted to a disk drive image or image file, which is then mounted to a virtual platform to simulate a bootable virtual hard drive (VHD) for the logical server.

It is desired to convert a disk drive or disk image configured for one system to another system with a significantly different hardware platform. It is also desired to automate the process to enable multiple and simultaneous conversion. The SysPrep tool and similar type tools (e.g., Symantec Ghost™) are limited to cloning systems with very similar or substantially the same hardware configurations. Any significant hardware difference results in failure in that the new system will not boot properly. Also, although the SysPrep tool saves some time for cloning a system, it is a one-to-one process suitable for cloning one system as a time. As a result, some computer manufacturers store thousands of different disk drive images, each suitable for a particular hardware and software configuration. The P2V tool and similar such existing tools suffer from similar limitations. The P2V tool is also a one-to-one process in which the physical drive information is modified while being streamed to an image file. Incompatibilities invariably exist between virtual machines and actual hardware machines. The target platform must be substantially similar or else the target logic server will fail, which often occurs for a significantly high percentage of attempts.

### SUMMARY OF THE INVENTION

A conversion system for converting a source disk image supporting a first hardware configuration into a target disk image supporting a second and different hardware configuration according to an embodiment of the present invention includes a first server that mounts the source disk image as a target disk drive, a repository that stores information and files useful for supporting the second hardware configuration, a rules library that facilitates conversion of hardware specific attributes in accordance with an external introspection process (EIP), and a conversion engine executed on the first server and interfaced with the repository and the rules library. The conversion engine performs the EIP by examining the source disk image on the target disk drive to determine modifications to convert to the target disk image.

Many alternatives and variations are contemplated. A target profile may be retrieved from the repository and used to determine the modifications. Alternatively, the conversion engine may include a profiler tool that generates a target profile when executed on a target server having the second hardware configuration, where the target profile is used to determine the modifications. The conversion engine may include an inspector tool that examines the source disk image to generate a source profile. The conversion engine may include a comparator tool that compares the source profile with a target profile incorporating information of the second hardware configuration. The conversion engine may include a simulator tool that simulates installations on the target disk drive and that generates conversion data. The conversion engine may include an assembler tool that generates a conversion plan incorporating the modifications.

The conversion engine may include a conversion tool that executes the conversion plan to make the modifications to the source disk image to achieve the target disk image. The conversion plan may be configured to remove existing hardware configuration information and to add new hardware configuration information. The conversion plan may further be configured to add and reconcile signature information. The conversion engine may conduct a test boot procedure that simulates booting a target server configured according to the second hardware configuration and mounted with the target disk drive including the modifications. Either one or both of the source and target disk images may be a hardware-neutral image.

The conversion system may include and image library that stores a master of the source disk image, where the image library is communicatively coupled to the first server. The repository may store at least one stock conversion plan retrievable by the conversion engine and that incorporates at least a portion of the modifications to convert the source disk image to the target disk image.

The conversion system may include a second server communicatively coupled to the first server, where the source disk image is mounted to the second server as the target disk drive. In this configuration, the conversion engine includes a master conversion engine executed on the first server and a remote conversion engine executed on the second server. The remote conversion engine is configured to examine the source disk image on the target disk drive to generate a source profile, to send the source profile to the master conversion engine, and to modify the target disk drive according to a conversion plan. The master conversion engine is configured to determine modifications to the source disk image using the source profile and to generate the conversion plan. The second server forwards the conversion plan to the second server.

The master conversion engine may include a comparator tool and an assembler tool. The comparator tool compares the source profile with a target profile to determine conversion information. The assembler tool assembles the conversion plan using the conversion information and the repository. The master conversion engine may further include a simulator tool that simulates installations on the target disk drive and that generates additional conversion data used to determine the conversion plan. The remote conversion engine may include a profiler tool, an inspector tool, and a conversion tool. The profiler tool examines the configuration of the second server to generate the target profile, where the second server forwards the target profile to the first server. The inspector tool examines the source disk image on the target disk drive to generate the source profile. The conversion tool executes the conversion plan to make the modifications to the target disk drive. The repository may store stock conversion plans retrievable by the master conversion engine.

A method of converting a source disk image supporting a first hardware configuration into a target disk image supporting a second and different hardware configuration according to an embodiment of the present invention includes mounting the source disk image as a target disk drive on a first server, storing information and files useful for supporting the second hardware configuration and library information that facilitates conversion of hardware specific attributes, and performing an external introspection process (EIP) by examining the source disk image on the target disk drive to determine conversion modifications to convert the source disk image to the target disk image.

The method may include retrieving a pre-stored target profile and using the target profile to determine the modifications. The method may include executing a profiler tool on a target server having the second hardware configuration to generate a target profile, and using the target profile to determine the conversion modifications. The method may include examining the source disk image to generate a source profile. The method may include comparing the source profile with a target profile incorporating information of the second hardware configuration. The method may include simulating installations on the target disk drive and generating conversion data. The method may include generating a conversion plan that incorporates the conversion modifications. The method may include executing the conversion plan to make the conversion modifications to the source disk image. Executing the conversion plan may include adding and reconciling signature information. The method may include simulating booting a target server configured according to the second hardware configuration and mounted with the target disk drive including the conversion modifications. The method may include storing a master of the source disk image. The method may include storing at least one stock conversion plan that incorporates at least a portion of the conversion modifications.

The method may further include mounting the source disk image as a target disk drive to a second server communicatively coupled to the first server, executing a master conversion engine on the first server and a remote conversion engine on the second server, examining, by the remote conversion engine, the source disk image on the target disk drive to generate a source profile, forwarding the source profile to the first server, determining, by the master conversion engine, modifications to the source disk image using the source profile, generating, by the master conversion engine, a conversion plan, forwarding the conversion plan to the second server, and modifying, by the remote conversion engine, the target disk drive according to the conversion plan.

The method may include comparing, by the master conversion engine, the source profile with a target profile to determine conversion information, and assembling, by the master conversion engine, the conversion plan using the conversion information and pre-stored repository information. The method may include simulating, by the master conversion engine, installations on the target disk drive and generating additional conversion data to determine the conversion plan. The method may include examining, by the remote conversion engine, the configuration of the second server to generate the target profile, forwarding the target profile to the first server, examining, by the remote conversion engine, the source disk image on the target disk drive to generate the source profile, and executing, by the remote conversion engine, the conversion plan to make the conversion modifications to the target disk drive. The method may include storing stock conversion plans retrievable by the master conversion engine.

### BRIEF DESCRIPTION OF THE DRAWING(S)

The benefits, features, and advantages of the present invention will become better understood with regard to the following description, and accompanying drawing in which:

FIG. 1 is a simplified block diagram of a computing structure including a conversion system implemented according to an exemplary embodiment of the present invention;

FIG. 2 is a flowchart diagram illustrating exemplary operation of an external introspection process (EIP) performed by the conversion engine of FIG. 1;

FIG. 3 is a more detailed block diagram of the conversion system of FIG. 1 according to an exemplary embodiment of the present invention; and

FIG. 4 is a simplified block diagram of an extended conversion system implemented according to another exemplary embodiment of the present invention.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

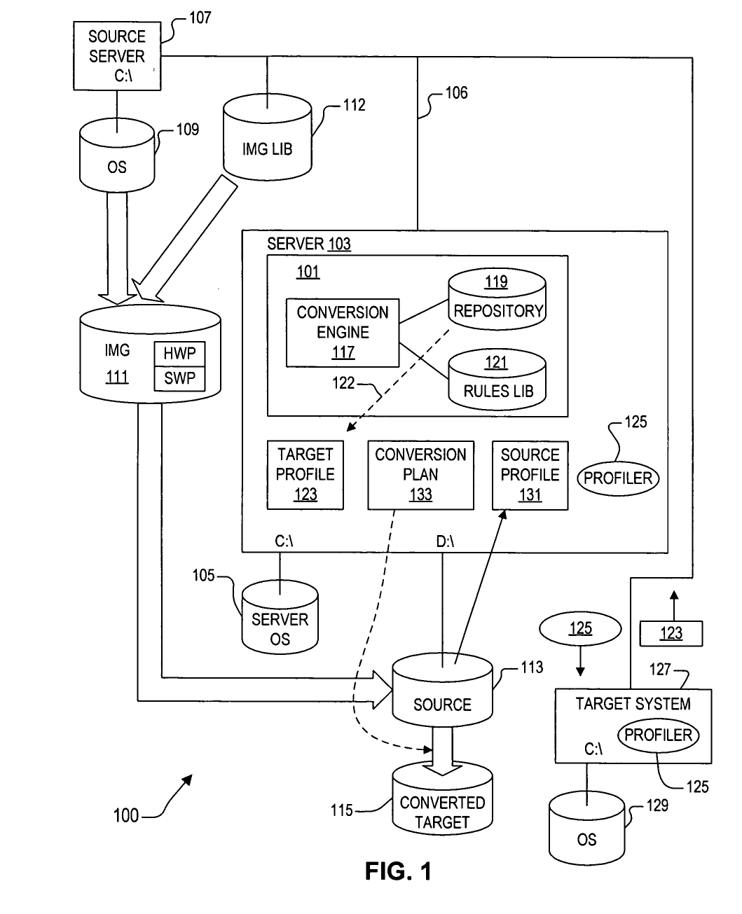

FIG. 1 is a simplified block diagram of a computing structure 100 including a conversion system 101 implemented according to various exemplary embodiments of the present invention. The conversion system 101 is shown located on a server 103, which is configured either as a physical server (PS) or as a logical server (LS). A LS is typically operated on an underlying PS using virtualization software or the like. A hard disk drive 105 is mounted to the server 103 and incorporates system information and the OS of the server 103. As shown, for example, the disk drive 105 is mounted as the boot drive C:\ of the server 103. In one embodiment, a separate source server 107 is shown mounted with a bootable source disk drive 109 (as drive C:\) with its own OS and associated with the source server 107. The servers 103 and 107 are communicatively coupled, such as via any suitable network 106 or the like.

The conversion system 101 operates to convert a “source” image into a converted “target” image. In one embodiment, the source image is a “bootable” image in that it serves as the boot drive for a computer implemented according to a specific hardware configuration. Alternatively, the source image may be a hardware-neutral image in that it does not include hardware-specific information. The neutral image is a boot image that may be capable of booting successfully using some minimal hardware configurations in which suitable self-discovery processes are capable of gathering sufficient hardware information during the boot process. In general, however, the neutral image is not bootable because it lacks sufficient information to run on any hardware. A neutral image is converted to a bootable image for any selected hardware platform using the conversion process described herein.

In accordance with a first embodiment, the drive 109 is converted or otherwise copied into an image (IMG) file 111, which is a portable description of hardware persistent storage (e.g., the drive 109) including hardware specific configuration information and drivers associated with the source server 107. The image file 111 may be a single file or a volume including multiple files collectively forming a file set. The image file 111 includes hardware profile (HWP) information and software profile (SWP) information of the drive 109 suitable for enabling the source server 107 to be booted using the drive 109. The source server 107 is either a physical server or a logical (or virtual) server. For a physical server, the disk drive 109 is disconnected or the HWP and SWP information is copied into the separate image file 111. For a logical server, the HWP and SWP information is either copied into a separate image file or the system 107 is shut down or otherwise deactivated and the drive 109 is removed or otherwise un-mounted to form the separate image file 111.

In an alternative embodiment, the image file 111 is retrieved from a separate image library 112 storing one or more source image files. The image library 112 is communicatively coupled to the server 103, such as via the network 106 or the like. Each stored image file in the image library 112 is associated with a corresponding server “class” or “type” having a corresponding hardware configuration or is otherwise hardware-neutral and not associated with any particular hardware configuration. An image file for a server type includes generic hardware configuration information about particular types of hardware (e.g., a particular type of CPU, NIC, hard disk drive, etc.) but does not necessarily include specific hardware identification information, otherwise referred to as “signature” information. Signature information includes specific identification values for specific equipment or hardware devices, such as, for example, CPU and/or disk drive serial numbers, network interface card (NIC) MAC addresses, etc. Such signature information is generally known by the OS via links, references or addresses and the like. Generic hardware configuration information is associated with a hardware type or device class (e.g., CPU type, hard drive type, NIC type, etc.) and does not necessarily identify an actual piece of hardware. During the EIP, signature information may be removed and/or replaced and it is usually necessary to reconcile such information with the OS, such as by updating links and references and the like. The discovery process performed during boot is often sufficient to perform signature information reconciliation. If the EIP performs such reconciliation prior to the booting process, the boot process is successful without any such discovery process since all information required for successful boot and operation is preconfigured and known.

The hardware specific or hardware neutral image file 111 is retrieved or otherwise copied forming a target image 113, which is then mounted as a disk drive onto the server 103. As shown, for example, the source image 113 is mounted as the D:\ drive of the server 103. As initially mounted, the source image 113 becomes a source disk drive 113 which is modified, as further described below, to a converted target disk drive 115. The items 113, 115 are considered images when not mounted to a server and disks when mounted, and each are referred to herein as an image/disk.

The source image/disk 113 is mounted to the server 103 as a non-booted drive to enable full access by the conversion system 101 to the image information contained within. The conversion system 101 performs an external introspection process (EIP) to convert the source image/disk 113 into the converted target image/disk 115, which is a neutral image or an image suitable for booting on a target server. In general, the EIP examines and modifies a non-booted image of a specific hardware image into a neutral image or into a different bootable hardware specific image. During the conversion, the source image/disk 113 is not booted but instead is mounted as a separate disk on the server 103 so that the image data therein is fully accessible and modifiable by the conversion system 101.

The conversion system 101 illustrated includes a conversion engine 117, a repository 119 and a rules library 121. The conversion engine 117 includes one or more process tools, further described below, and generally performs the EIP to transform an image from one hardware platform to another (or between neutral and hardware-specific platforms). The repository 119 includes the OS components, e.g., binary files, drivers, HALs, service packs, etc., that are needed to convert and/or update the source disk/image 113 into the target image/disk 115. The conversion engine 117 includes analysis tools that operate according to a set of internal rules and/or rules located within the rules library 121. The rules facilitate identification, modification, removal and insertion of hardware specific attributes during performance of the EIP. In general, the EIP performs conversion from one system to another regardless of type of platform of the source or target system.

Thus, the EIP converts a bootable disk drive compatible with a first platform (either physical or virtual) into a different bootable drive compatible with a different platform (either physical or virtual) regardless of the differences in the hardware configurations. The converted bootable image includes hardware configuration information suitable for a particular class or type of machine and may optionally include signature information associated with a specific server with identified hardware. The converted image may be booted on a target system or stored for later retrieval. In yet another alternative embodiment, the EIP modifies a source drive (e.g., drive 109) to a neutral image, which is an image without hardware specific information. The neutral image may contain sufficient information to enable booting on some target systems with self-discovery functionality. Alternatively, the neutral image file is stored and later retrieved and converted to bootable format for any selected target server. Neutral images provide the advantage of reducing any time needed to remove source hardware information before conversion.

While performing the EIP, the conversion engine 117 retrieves or otherwise generates a target profile 123 of a target system. The target profile 123 is provided from any one of multiple sources. In one case, the target profile 123 is retrieved from the repository 119 as indicated by dashed line 122. The target profile 123 may be a neutral image or associated with a more specific target hardware configuration. For a hardware-specific case, the target profile 123 includes one or more files storing generic hardware specific information associated with a particular class or type of machine or equipment, such as the registry, drivers, configuration, information (INF) files, HAL, etc. The target profile 123 may further include the signature information associated with specific and identified hardware devices, if such information is known and available.

The conversion engine 117 includes a profile tool (or “profiler”) 125, which is executed on a target server to discover the profile data and configuration information and to load the information into the target profile 123. If the server 103 is the target server, then the OS 105 of the server 103 executes the profile tool 125 locally to determine the hardware configuration of the server 103. Alternatively, the profiler tool 125 is downloaded to a target system, such as a target system 127 communicatively coupled via the network 106 or the like. The target system 127 includes its own boot disk 129 with its own OS, and effectively forms a working instance of the desired OS on the target hardware. The profiler tool 125 is executed on the target system 127 and is generally tasked to identify the generic hardware configuration information, such as including registry, drivers, and the other items needed to operate the OS on disk 129 on the target hardware. The target profile 123 generated by the profile tool 125 executed on the server 127 is forwarded back to the server 103 for analysis, conversion and/or storage in the repository 119 for later use. The profiler tool 125 may optionally be further tasked to discover and record signature information of specific hardware. Signature information is desired if the target profile 123 is intended for an identified target with specific hardware. Otherwise, if the target profile is intended for a generic server type or for storage into the repository 119, then only generic hardware configuration is collected.

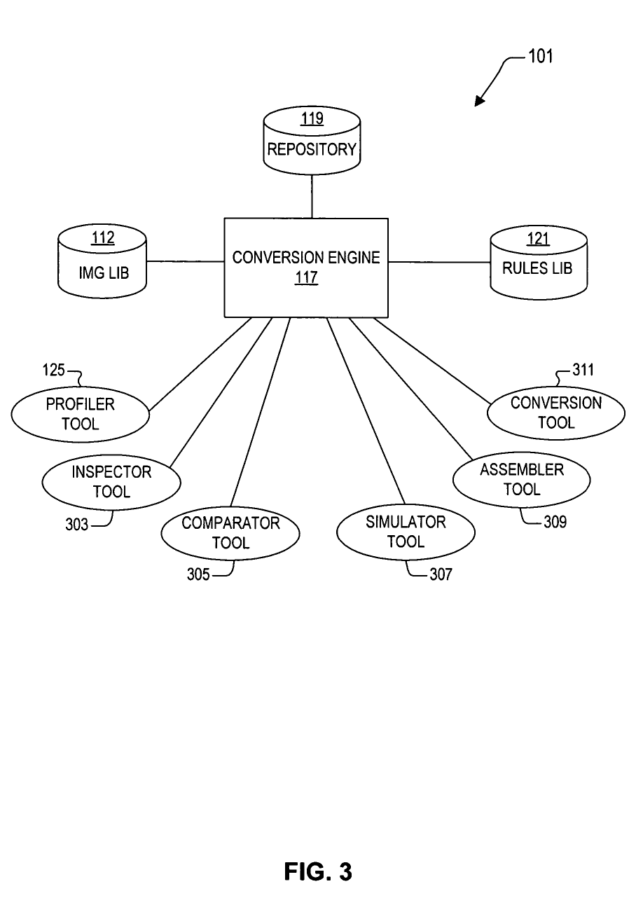

The EIP also generates a source profile 131 from the source image/disk 113 to determine current drivers and settings of the source image. The inspection process is performed on the source image/disk 113 and includes review of registry, drivers, configuration files, and any other information needed to generate the source profile 131, which may include similar types of information and have a similar format as the target profile 123. The inspection process, further described below, may be implemented in a similar manner as the profiler 125 and provided in a separate executable form, such as an inspector tool 303 (FIG. 3). The inspector tool 303 can be executed on the server 103 for inspecting the source image/disk 113 to generate the source profile 131. Alternatively, the inspector tool is transferred to, and executed by, a source server system to generate the source profile 131. For example, the inspection tool 303 may be downloaded to and executed on the source server 107 to generate the source profile 131, which may then be transferred back to the server 103. The EIP compares the profiles 123 and 131 and optionally performs other analysis functions and generates an action or conversion plan 133. The conversion plan 133 is extensible and may be modified, adjusted or “tweaked”, as further described below. The conversion plan 133 is used by the EIP to perform the changes into the source image/disk 113 to create the converted target image/disk 115. At least one goal is to enable the converted target image/disk 115 to successfully boot up on a target system, such as the server 103 or a separate target system 127 or the like, with little or no need for any discovery process. Alternatively, the target image is hardware-neutral suitable for booting on a generic system or stored for later retrieval and modification as desired.

The general EIP includes removal of old or source hardware configuration information resulting in a hardware neutral image, and/or insertion of new or target hardware configuration information resulting in a bootable image for a server type. Many variations and alternatives of the EIP are contemplated. The EIP may further include instructions or the like to insert signature information into the target image and to reconcile the inserted signature information with the OS on the converted target image/disk 115 as previously described. Simplifications are also contemplated. Once the source profile 131 is retrieved or generated, the conversion engine 117 may perform little or no analysis and directly perform the modifications of the source image/disk 113. The target profile 123 might not be used if converting to a hardware-neutral image. For direct conversion operation, the conversion plan 133 is not used. Alternatively, a “canned” or “stock” conversion plan is retrieved, such as from the repository 119, and directly used or otherwise tweaked and then used to perform the desired modifications.

Additional functions are also contemplated. For example, in one embodiment, once the converted target image/disk 115 is generated, a test boot procedure is performed in which the server 103 invokes a test target logical server system (not shown) simulating or otherwise replicating the hardware configuration of the target system. The converted target image/disk 115 is mounted to the test target system and a boot is initiated. If for any reason the boot fails or is not completely successful, the problems are identified and the conversion plan 133 is tuned or the converted target image/disk 115 is otherwise reconfigured or further modified and the test boot is run again. The test boot procedure may be repeated as often as necessary to achieve a successful boot.

The EIP performs removal of old and insertion of new hardware details prior to boot and discovery via surgical manipulation of one or more images to conform with target hardware or to provide a neutral image. The EIP performs differencing based on rules or the like and may itself comprise or otherwise utilize artificial intelligence (AI). In many cases particularly if signature information is available, inserted and reconciled, the EIP does not require the discovery procedures or unstable boots; the discovery process is not relied upon for successful boot because the image is correct before boot. EIP does not require virtualization and images can be directly manipulated as files, although EIP can use virtualization to facilitate reading image files. In one embodiment, only hardware-specific items are changed with minimal impact to the source image. Alternatively or in addition, the EIP manipulates other parts of the image as needed or desired. In one embodiment, for example, the EIP provides software patches, upgrades, software installs, and can even perform a virus scan on the target drive. It is noted that the source and target servers may be the same, where the source image from the target system is patched, upgraded, improved and/or scanned, and then returned and re-mounted back onto the original server.

The EIP may convert one image into multiple images for multiple platforms simultaneously. The imaging process is optional, in which the process may be applied on a raw drive and then moved to new equipment. If, for any reason, full pre-configuration is not practicable, elements needed for the discovery process are optionally pre-staged to facilitate boot and the discovery process. If the conversion engine 117 has complete knowledge of the target platform such as including generic hardware configuration and signature information, then the boot process on the target system is clean and does not require any discovery. Complete target knowledge, however, is not required since the target image can be manipulated to be generic and generally bootable in which additional processes (e.g., Plug and Play, SysPrep, bootstrap, manual processes, etc.) may be expected to complete the configuration without error. For example, if the hardware types are known without signature information, then the boot process may require minimal discovery to reconcile the signature information. The target knowledge is not required to convert to a hardware-neutral image.

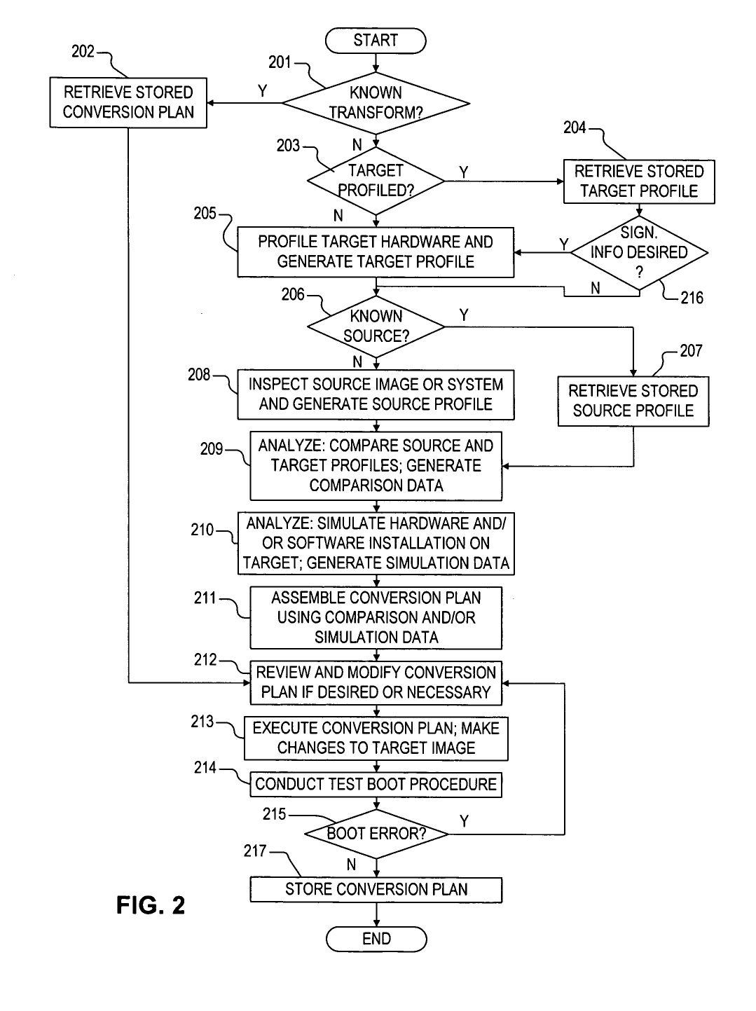

FIG. 2 is a flowchart diagram illustrating operation of an exemplary embodiment of the EIP performed by the conversion engine 117. At first decision block 201, it is queried whether the transform is known in which the conversion from a substantially identical source to a substantially identical target has been previously performed and a conversion plan has already been generated and stored. If the transform is known, operation proceeds to block 202 in which a previously stored conversion plan is retrieved from the repository 119. If the transform is not known, operation proceeds instead to decision block 203 in which it is queried whether the target has been previously profiled. If the target profile has not been previously profiled or if it is desired to perform additional profiling, operation proceeds to block 205 in which the target hardware is profiled to capture hardware specific information and files, which data and information is stored in the target profile 123. The generated target profile 123 includes generic hardware configuration information and may further include signature information. The target profile 123 includes one or more files that can be used to analyze system differences. The target profile function may be skipped if converting to a neutral image or if the discovery process is sufficient to achieve successful boot of the target server. If the target has been previously profiled, operation proceeds instead to block 204 in which the target profile is retrieved from the repository 119. Stored profiles usually include only generic hardware configuration information and not signature information. Operation proceeds to block 216 to determine whether the target should be profiled to retrieve signature information, and if so, to block 205 for further profiling.

After the target profile is retrieved (from block 204) or generated (from block 205), operation proceeds to next decision block 206 in which it is queried whether the source is known. If the source is known, then operation proceeds to block 207 in which the stored source profile is retrieved from the repository 119. If the source is not known, operation proceeds instead to block 208 in which the source image/disk 113 is inspected to determine the drivers and settings of the source system or the source image. The inspection process includes review of the registry, drivers, configuration files etc., and the results of the inspection process are stored in the source profile 131. The source inspection may be skipped if the source is itself a neutral image. After the source profile is retrieved (from block 207) or generated (from block 208), operation proceeds to next block 209 in which the profiles 123 and 131 are compared to analyze the results of the target profiles and source inspection. The comparison process may employ rules from the rules library 121, and/or may conduct a side-by-side comparison and analysis of register, drivers, configuration files, etc. At next block 210, a simulation of running hardware and/or software installations on the target system is performed using existing INF files or similar installer scripts. The simulation detects changes to registry, configuration files, drivers, etc., that are needed on the target hardware, and determines the modifications needed to make it appear as though installation of the hardware and software had been run on the target system using the target disk.

At next block 211, the conversion plan 133 is assembled using the comparison results from block 209 and the simulation results from block 210 if performed. At next block 212, the retrieved conversion plan (from block 202) or the generated conversion plan 133 (from block 211) is optionally reviewed (e.g., according to predetermined rules) or otherwise manually tweaked and modified, if desired, prior to execution and conversion. At next block 213, the conversion plan is executed to make changes of the source image/disk 113 to generate the converted target image/disk 115. During the execution of the conversion plan, old hardware configuration information, if any, is removed resulting in a hardware neutral image. New hardware configuration information is then inserted according to the target profile 123. If signature information is available, it is written into the target image and reconciled. The conversion process during execution of the conversion plan includes changes to the registry, the configuration files, etc., and indicates files that need to be modified, replaced and/or moved. The repository 127 stores the files that may be needed for the conversion process and/or the target image.

At next block 214, a test boot procedure is optionally performed using the converted target image/disk 115 mounted to a test target server. If the test boot procedure is conducted, the test target server is initialized, the image/disk 115 is mounted and a boot is attempted. If the boot is unsuccessful as indicated by an error decision block 215, then the converted target image/disk 115 is modified either directly, or operation returns back to block 212 in which further adjustments are made to the conversion plan. The adjusted conversion plan is re-executed at block 213 and the test boot procedure is once again conducted at block 214. The test boot procedure is performed as often as necessary or otherwise practicable to achieve a successful boot. Once a successful conversion plan is achieved, it is optionally stored at block 217. As previously described, many steps of the EIP may be skipped or simplified and/or additional steps added depending upon the particular situation. It is contemplated that the test boot procedure, for example, is unnecessary for many conversions.

FIG. 3 is a more detailed block diagram of the conversion system 101 according to an exemplary embodiment of the present invention. The conversion engine 117 is shown interfaced to the image library 112, the repository 119 and the rules library 121. The conversion engine 117 includes or otherwise interfaces and invokes multiple process tools to perform the conversion process. As shown, the tools include the profiler tool 125, the inspector tool 303, a comparator tool 305, a simulator tool 307, an assembler tool 309 and a conversion tool 311. The profiler tool 125 is executed on the target system as previously described to generate the target profile 123. The inspector tool 303 is executed on a source system, or otherwise inspects the source image/disk 113 to generate the source profile 131. The comparator tool 305 compares the profiles 123 and 131 to generate comparison data and the simulation tool 307 is executed to simulate hardware and/or software installation to generate additional conversion information. The installation simulation, for example, detects changes to the registry, the configuration files, etc., and determines additional files (e.g., drivers and the like) that are needed on the target hardware. The installation simulation determines the changes needed to make it appear as though installation had been directly run on the target server. The comparison data and conversion information is used by the assembler tool 309 to assemble the conversion plan 133. The conversion plan 133 is executed by the conversion tool 311 to generate the converted target image/disk 115 as previously described.

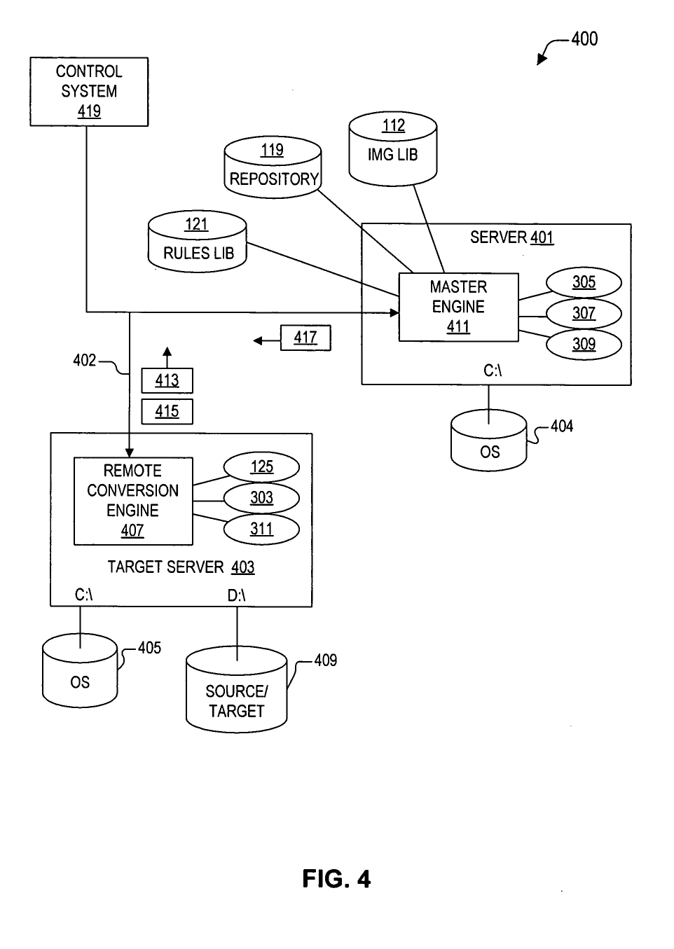

FIG. 4 is a simplified block diagram of an extended conversion system 400 implemented according to another exemplary embodiment of the present invention. The functions of the conversion engine 117 are divided into a master engine 411 and a remote conversion engine 407. The master engine 411 is executed by an OS located on a bootable disk drive 404 of a master server 401 and the remote conversion engine 407 is executed by an OS located on a bootable disk drive 405 of a target server 403. The master server 401 and the target server 403 communicate via an appropriate communication network 402. In one embodiment, for example, the target server 403 is coupled via the network 402 and the remote conversion engine 407 is downloaded from the master engine 411 on the server 401. The source/target image is mounted as a target disk 409 on the target server 403. The remote conversion engine 407 incorporates portions of the conversion engine 125 including the profiler tool 125, the inspector tool 303 and the conversion tool 311, or versions thereof. The master engine 411 includes analysis tools, such as the comparator tool 305, the simulator tool 307, and the assembler tool 309. The repository 119 and the rules library 121 may be located on the master server 401 or otherwise interfaced to the master engine 411 via the network 402. Although the master engine 411 may also incorporate the test boot procedure, the target disk 409 is remotely located and may not be readily available to conduct a boot.

The profiler tool 125 is executed by the OS 405 to generate a target profile 413 based on the configuration of the target server 403. The inspector tool 303 is executed on the target server 403 and inspects the source/target disk 409 and generates the source profile 415. The profiles 413, 415 are forwarded to the master engine 411 via the network 402. The target profile 413 is optionally stored in the repository 119, which is useful if multiple conversions are to be made to server types represented by the target server 403 (e.g., similar machine and/or hardware devices and configurations). The master engine 411 invokes the comparator tool 304 and the simulator tool 307 using the profiles 413, 415, and runs the assembler tool 309 to generate a conversion plan 417. The conversion plan 417 is optionally stored into the repository 119. The conversion plan 417 is forwarded from the master server 401 to the target server 403, which executes the conversion tool 311 to convert the target disk 409 into a bootable disk for the target server 403. The components may be moved between the master engine 411 and the remote conversion engine 407 as necessary or desired. An optional external control system 419 is provided and coupled to the servers 401 and 403, such as via the network 402, to control the EIP and/or to automate the processes. The control system 419 may perform various other functions including effectuating changes to the system 403, such as shutdown, start, drive changes, etc., to automate the process.

The extended conversion system 400 enables the system to have more generic rules that can be applied to a broader range of targets. It is generally easier to maintain a single rules library, where the rules are either maintained by a central authority or by multiple entities in which case the separate portions are aggregated by the master engine 411 as needed. A separate master rules library is also applicable to the conversion system 101 for easier maintenance. For example, the rules library 121 need not be part of the conversion system 101 but instead is accessible via an appropriate communications link, such as the network 106. Another benefit of using an external master engine is that it facilitates the EIP to work more interactively with virtualization. For example, a new logical server LS is created, the target disk is converted, detached and mounted to the new LS as its primary boot disk, and the LS is booted. Such may be done, for example, to invoke the target server for service or to perform the boot test procedure.

It is appreciated that an image conversion engine configured for hardware agnostic manipulation and management of image resources according to various embodiments of the present invention performs the EIP that enables conversion of a disk drive or disk image configured for one system to a bootable image compatible with a second system even if the second system has a significantly different hardware platform. The source and target systems may be physical or virtual so that conversion is successful between physical platforms, between virtual platforms, or between physical and virtual platforms. The image conversion engine may optionally be configured to automate the EIP to enable multiple and simultaneous conversions. Target profiles and/or conversion plans are stored for later retrieval and use to facilitate similar conversions. The image conversion engine may optionally be configured for remote conversions across a network or the like. The image conversion engine is not limited to cloning systems with very similar or substantially the same hardware configurations, but may be performed even between servers with significant hardware differences while ensuring a successful boot.

The image conversion engine is not limited to conversion between two different systems or conversions of operating systems. Non-hardware related changes are contemplated for a single system, such as software patches, virus scans, detections and removals, software installations, etc. The EIP may further effectuate installation of new hardware on a given system or between systems. Any such modifications may be made without booting the target system. For example, a source profile from an existing computer or server may be generated or retrieved and modified and then employed to update or upgrade the same computer. Such transformation may be performed remotely via a network or the like, in which case a conversion plan is downloaded and executed to effectuate the changes. Thus, large bootable images may be modified without being moved or copied.

Appendix A illustrates exemplary code of a sample conversion plan with a subset of the instructions to convert an image of a virtual machine (logical server) to run on a GX240 computer system manufactured by Dell Inc. The illustrated subset of instructions are limited and related to the conversion of the Display/Monitor category of hardware only.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for providing out the same purposes of the present invention without departing from the spirit and scope of the invention as defined by the following claims.

1. A conversion system for converting a source disk image supporting a first hardware configuration into a target disk image supporting a second and different hardware configuration, comprising:
a first server that mounts the source disk image as a target disk drive;
a repository that stores information and files useful for supporting the second hardware configuration;
a rules library that facilitates conversion of hardware specific attributes in accordance with an external introspection process (EIP); and
a conversion engine, executed on said first server and interfaced with said repository and said rules library, that performs said EIP by examining the source disk image on said target disk drive to determine modifications to convert to the target disk image.

2. The conversion system of claim 1, wherein a target profile is retrieved from said repository and used to determine said modifications.

3. The conversion system of claim 1, wherein said conversion engine includes a profiler tool that generates a target profile when executed on a target server having the second hardware configuration, wherein said target profile is used to determine said modifications.

4. The conversion system of claim 1, wherein said conversion engine includes an inspector tool that examines the source disk image to generate a source profile.

5. The conversion system of claim 4, wherein said conversion engine includes a comparator tool that compares said source profile with a target profile incorporating information of the second hardware configuration.

6. The conversion system of claim 1, wherein said conversion engine includes a simulator tool that simulates installations on said target disk drive and generates conversion data.

7. The conversion system of claim 1, wherein said conversion engine includes an assembler tool that generates a conversion plan that incorporates said modifications.

8. The conversion system of claim 7, wherein said conversion engine includes a conversion tool that executes said conversion plan to make said modifications to the source disk image to achieve said target disk image.

9. The conversion system of claim 8, wherein said conversion plan is configured to remove existing hardware configuration information and to add new hardware configuration information.

10. The conversion system of claim 9, wherein said conversion plan is configured to add and reconcile signature information.

11. The conversion system of claim 1, wherein said conversion engine conducts a test boot procedure that simulates booting a target server configured according to the second hardware configuration and mounted with said target disk drive including said modifications.

12. The conversion system of claim 1, wherein a selected one of the source and target disk images is a hardware-neutral image.

13. The conversion system of claim 1, further comprising an image library storing a master of the source disk image, wherein said image library is communicatively coupled to said first server.

14. The conversion system of claim 1, wherein said repository stores at least one stock conversion plan retrievable by said conversion engine and that incorporates at least a portion of said modifications to convert the source disk image to the target disk image.

15. The conversion system of claim 1, further comprising:
a second server communicatively coupled to said first server, wherein the source disk image is mounted to said second server as said target disk drive;
said conversion engine including a master conversion engine executed on said first server and a remote conversion engine executed on said second server;
said remote conversion engine configured to examine the source disk image on said target disk drive to generate a source profile, to send said source profile to said master conversion engine, and to modify said target disk drive according to a conversion plan; and
said master conversion engine configured to determine modifications to the source disk image using said source profile and to generate said conversion plan;
wherein said second server forwards said conversion plan to said second server.

16. The conversion system of claim 15, wherein said master conversion engine comprises:
a comparator tool that compares said source profile with a target profile to determine conversion information; and
an assembler tool that assembles said conversion plan using said conversion information and said repository.

17. The conversion system of claim 16, wherein said master conversion engine further comprises a simulator tool that simulates installations on said target disk drive and generates additional conversion data used to determine said conversion plan.

18. The conversion system of claim 16, wherein said remote conversion engine comprises:
a profiler tool that examines the configuration of said second server to generate said target profile, wherein said second server forwards said target profile to said first server;
an inspector tool that examines the source disk image on said target disk drive to generate said source profile; and
a conversion tool that executes said conversion plan to make said modifications to said target disk drive.

19. The conversion system of claim 15, wherein said repository stores a plurality of stock conversion plans retrievable by said master conversion engine.

20. A method of converting a source disk image supporting a first hardware configuration into a target disk image supporting a second and different hardware configuration, comprising:
mounting the source disk image as a target disk drive on a first server;
storing information and files useful for supporting the second hardware configuration and library information that facilitates conversion of hardware specific attributes; and
performing an external introspection process (EIP) by examining the source disk image on the target disk drive to determine conversion modifications to convert the source disk image to the target disk image.

21. The method of claim 20, further comprising retrieving a pre-stored target profile and using the target profile to determine the modifications.

22. The method of claim 20, further comprising:
executing a profiler tool on a target server having the second hardware configuration to generate a target profile; and
using the target profile to determine the conversion modifications.

23. The method of claim 20, further comprising examining the source disk image to generate a source profile.

24. The method of claim 23, further comprising comparing the source profile with a target profile incorporating information of the second hardware configuration.

25. The method of claim 20, further comprising simulating installations on the target disk drive and generating conversion data.

26. The method of claim 20, further comprising generating a conversion plan that incorporates the conversion modifications.

27. The method of claim 26, further comprising executing the conversion plan to make the conversion modifications to the source disk image.

28. The method of claim 27, wherein said executing the conversion plan includes adding and reconciling signature information.

29. The method of claim 20, further comprising simulating booting a target server configured according to the second hardware configuration and mounted with the target disk drive including the conversion modifications.

30. The method of claim 20, further comprising storing a master of the source disk image.

31. The method of claim 20, further comprising storing at least one stock conversion plan that incorporates at least a portion of the conversion modifications.

32. The method of claim 20, further comprising:
mounting the source disk image as a target disk drive to a second server communicatively coupled to the first server;
executing a master conversion engine on the first server and a remote conversion engine on the second server;
examining, by the remote conversion engine, the source disk image on the target disk drive to generate a source profile;
forwarding the source profile to the first server;
determining, by the master conversion engine, modifications to the source disk image using the source profile;
generating, by the master conversion engine, a conversion plan;
forwarding the conversion plan to the second server; and
modifying, by the remote conversion engine, the target disk drive according to the conversion plan.

33. The method of claim 32, further comprising:
comparing, by the master conversion engine, the source profile with a target profile to determine conversion information; and
assembling, by the master conversion engine, the conversion plan using the conversion information and pre-stored repository information.

34. The method of claim 33, further comprising simulating, by the master conversion engine, installations on the target disk drive and generating additional conversion data to determine the conversion plan.

35. The method of claim 33, further comprising:
examining, by the remote conversion engine, the configuration of the second server to generate the target profile;
forwarding the target profile to the first server;
examining, by the remote conversion engine, the source disk image on the target disk drive to generate the source profile; and
executing, by the remote conversion engine, the conversion plan to make the conversion modifications to the target disk drive.

36. The method of claim 32, further comprising storing a plurality of stock conversion plans retrievable by the master conversion engine.
